(19) United States
(12) Patent Application Publication
(10) Pub. No.: US 2023/0278830 A1
(43) Pub. Date: Sep. 7, 2023

(54) A STAIRLIFT

(71) Applicant: STANNAH STAIRLIFTS LIMITED, Andover, Hampshire (GB)

(72) Inventor: Max Daniel Woodhams, Andover, Hampshire (GB)

(21) Appl. No.: 18/024,447

(22) PCT Filed: Sep. 6, 2021
(86) PCT No.: PCT/GB2021/052286

§ 371 Date: Mar. 2, 2023

(30) Foreign Application Priority Data
Sep. 7, 2020 (GB) 2014000.0

(51) Int. Cl. B66B 9/08

(52) U.S. Cl. CPC B66B 9/0838

(57) ABSTRACT

A stairlift has a load carrier, or chair, which can be levelled in both roll and pitch. Two level drive motors are provided which engage with a levelling wheel centred on the roll axis and when the level drive motors are driven in the same direction, the load carrier is driven about the roll axis. A linkage connects the level drive motors with the load carrier and is configured such that, when the level drive motors are driven in opposite directions, movement of the load carrier about the pitch axis is induced.

### CROSS-REFERENCE TO RELATED APPLICATIONS

This application is the U.S. National Stage of PCT/GB2021/052286 filed on Sep. 6, 2021, which claims priority to United Kingdom Patent Application 2014000.0 filed on Sep. 7, 2020, the entire content of both are incorporated herein by reference in their entirety.

### FIELD OF THE INVENTION

This invention relates to stairlifts and, in particular, to a curved stairlift in which the load carrier, typically a chair, must be maintained level as the stairlift carriage moves through bends in the stairlift rail between rail sections which are inclined a different angles with respect to a horizontal datum and/or through bends that curve around a vertical axis.

### BACKGROUND TO THE INVENTION

It is a well-known feature of curved stairlifts that, during travel between the upper and lower ends of the stairlift rail, relative rotation between the chair and the stairlift carriage must be induced as the carriage moves through transition bends in the rail. This is to ensure that the seat surface of the chair remains substantially horizontal at all times. Rotation about this axis is often referred to as roll and one example of an arrangement to control roll is described in our published International Patent Application No. WO95/18763.

In some stairlift installations the stairlift chair may also be tilted forward or backward as the carriage moves through certain types of bend, this type of rotation often being referred to a pitch. By way of example only, pitch may arise from configuring the bends so that the rail can be placed as close as possible to a wall or other boundary of the environment in which the stairlift is mounted. Pitch can also arise from limitations in accurately manufacturing and/or installing the stairlift rail. One means of addressing this problem is described in our published International Patent Application No. WO2007/091095. Other examples are described in published International Patent Application WO96/15974 and in UK Patent Application GB2409446. All of these arrangements require separately controlled motors to effect movement about the respective roll and pitch axes.

It is an object of the invention to provide a means of maintaining level of a stairlift chair that provides a novel and useful alternative to the arrangements referred to above.

### SUMMARY OF THE INVENTION

Accordingly, in a first aspect, the invention provides a stairlift including a stairlift rail; a carriage mounted on said rail for movement there-along; a load support mounted on said carriage, said load support being mounted on said carriage for pivotable movement with respect to the carriage about a first or roll axis, and about a second or pitch axis substantially perpendicular to said roll axis; and a plurality of level drive motors configured and operable in a first mode to rotate said load carrier about said roll axis wherein said stairlift further includes a linkage between said plurality of level drive motors and said load carrier, said linkage being configured to apply drive from said plurality of level drive motors, when operated in a second mode, to pivot said load carrier about said pitch axis.

Preferably said roll axis and said pitch axis intersect.

Preferably in said first mode, said plurality of level drive motors are driven in the same direction and, in said second mode, said plurality of level drive motors are driven in opposite directions.

Preferably said carriage includes a yoke configured to define said pitch axis and to receive said load support; and a pair of motor mount plates mounted to pivot about said roll axis, one of said plurality of level drive motors being mounted on each of said motor mount plates, said linkage engaging said load support at one or more positions spaced from said pitch axis such that, when said level drive motors are operated in said second mode, said motor mount plates are caused to pivot about said roll axis in opposite directions, and said load support is caused to pivot within said yoke about said pitch axis.

Preferably said linkage comprises in first part of a plurality of guide slots extending from said motor mount plates and angled with respect to said pitch axis; in second part of a plurality of arms extending from said load support, from positions on said load support spaced equidistant from said pitch axis; and in third part of a plurality of sliding connections extending between said guide slots and said arms and configured to control sliding movement of said guide slots relative to said arms.

Preferably said connections comprise or include bearings.

Preferably each of said guide slots includes a curved base surface.

Preferably said guide slots are aligned at substantially 45□ to said pitch axis.

Preferably said guide slots have a length and wherein said linkage is configured such that, when said level drive motors are driven in said first mode, each connection is positioned substantially midway along the length of its respective guide slot.

Preferably each of said plurality of level drive motors includes a drive pinion in engagement with a levelling wheel mounted on said roll axis, the respective drive pinions being positioned to engage said levelling wheel on opposite sides of a vertical diameter thereof.

Preferably when said level drive motors are operating in said first mode, said drive pinions engage said levelling wheel at opposite ends of a diameter thereof.

Preferably said drive pinions are positioned to engage said levelling wheel on opposite sides of a horizontal diameter thereof.

Many variations in the way the present invention can be performed will present themselves to those skilled in the art. The description which follows is one illustration only of a means of performing the invention and the lack of description of variants or equivalents should not be regarded as limiting. Subject to the scope of the appended claims, wherever possible, a description of a specific element should be deemed to include any and all equivalents thereof whether in existence now or in the future.

### BRIEF DESCRIPTION OF THE DRAWINGS

An embodiment of the invention will now be described with reference to the accompanying drawings in which:

FIG. 1 shows a partial isometric view of a stairlift levelling arrangement according to the invention in a neutral position;

FIG. 2 shows a front elevation of that which is shown in FIG. 1;

FIG. 3 shows a rear elevation of that which is shown in FIGS. 1 & 2;

FIG. 4 shows a side elevation of that which is shown in FIGS. 1 to 3;

FIG. 5 shows a view from above of that which is shown in FIGS. 1 to 4;

FIG. 6 shows a similar view to FIG. 5 but with certain components removed for the purposes of description;

FIG. 7 shows a view perpendicular to that shown in FIG. 8;

FIG. 8 shows a view along section X-X in FIG. 6;

FIG. 9 shows a view similar to FIG. 3 but with a load support rolled from the neutral position;

FIGS. 10A&10B show, respectively, similar views to FIGS. 3 & 6 but with the load support in position of negative pitch relative to the neutral position; and

FIGS. 11A&11B show respectively similar views to FIGS. 3 & 6 but with the load support in position of positive pitch relative to the neutral position.

### DETAILED DESCRIPTION OF WORKING EMBODIMENT

The present invention provides a means for maintaining a load support, typically a stairlift chair, level both in roll and in pitch as a stairlift carriage moves through bends in a stairlift rail. Roll, or the potential for roll, occurs when the stairlift carriage moves through a transition bend in the stairlift rail; that is to say, a bend in which the angle of travel varies with respect to a horizontal datum. Pitch, in the sense of this disclosure, is titling movement of the stairlift chair in a forward or rearward direction relative to the direction of travel which may occur when traversing a variety of bend types.

The accompanying drawings illustrate the operative parts of the invention, more particularly part of a stairlift carriage 20 and part of a load support 21 which is mounted to the carriage 20, the connection between the carriage and load support incorporating the invention. The load support 21 is shown for the sake of simplicity as a pillar to which, in most stairlift installations, a chair (not shown) will be mounted. A platform may be provided as an alternative to a chair, but the invention is not to be restricted to either.

The load support 21 is mounted to the carriage 20 to pivot about a first or roll axis 23 and a second or pitch axis 24. In this example, the first axis 23 is the roll axis and the second axis 24 is the pitch axis. The axes 23 and 24 are perpendicular to one another and preferably intersect.

In this example a levelling wheel 26 is fixedly mounted to the carriage 20 and centred on roll axis 23, the levelling wheel having a toothed outer periphery 27. Engaged with the toothed periphery 27 are a pair of pinions 28a, 28b driven by respective level drive motors 30a, 30b. So far this is conventional. The essence of the invention lies in the provision of a novel linkage that allows the motors that level about the roll axis, to also be used to achieve level about the pitch axis. In this example the linkage is provided in three parts as will become apparent from the description that follows.

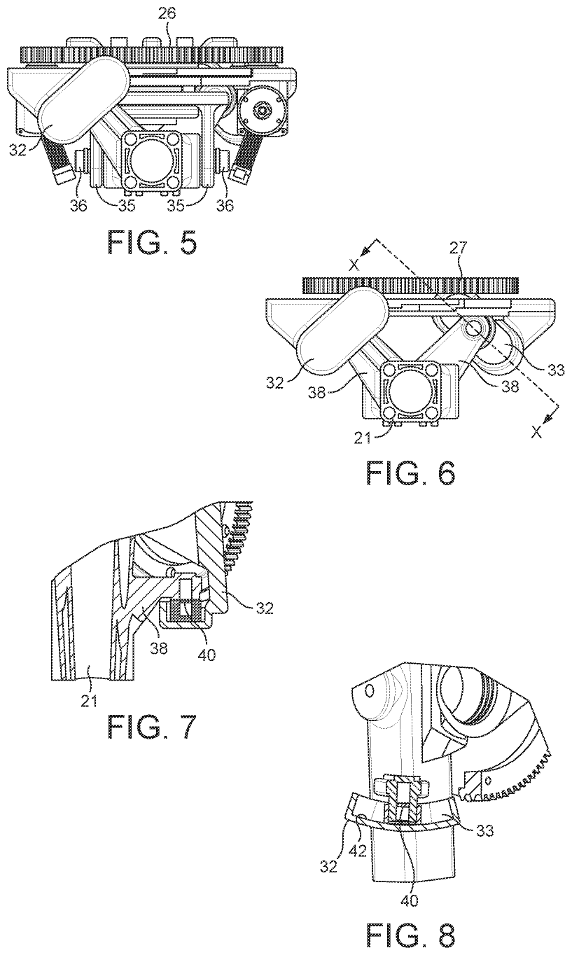

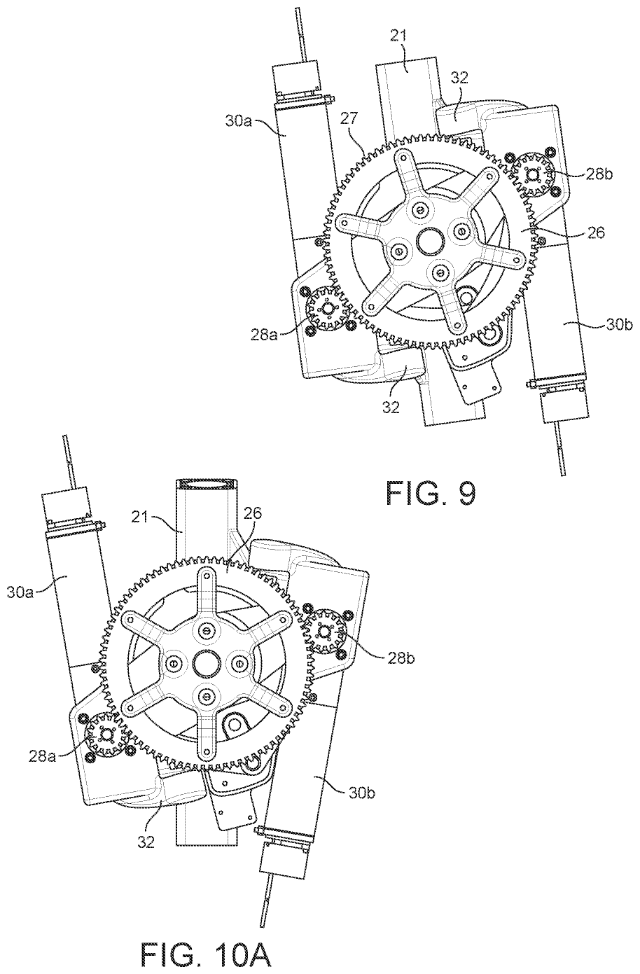

As shown, the level drive motors are mounted on motor mount plates 31, the motor mount plates, in turn, being mounted to the carriage 20 to pivot about the roll axis 23, independently of the levelling wheel 26. Positioned on the outer end of each motor mount plate 31 is a first part of the linkage in the form of a bracket 32 containing a guide slot 33. As can be seen most clearly in FIGS. 5 & 6, the brackets 32 and guide slots 33, which are substantially linear when viewed in plan, are angled with respect to a vertical plane through the pitch axis 24. The angle may, for example, be 45□ but this is not critical.

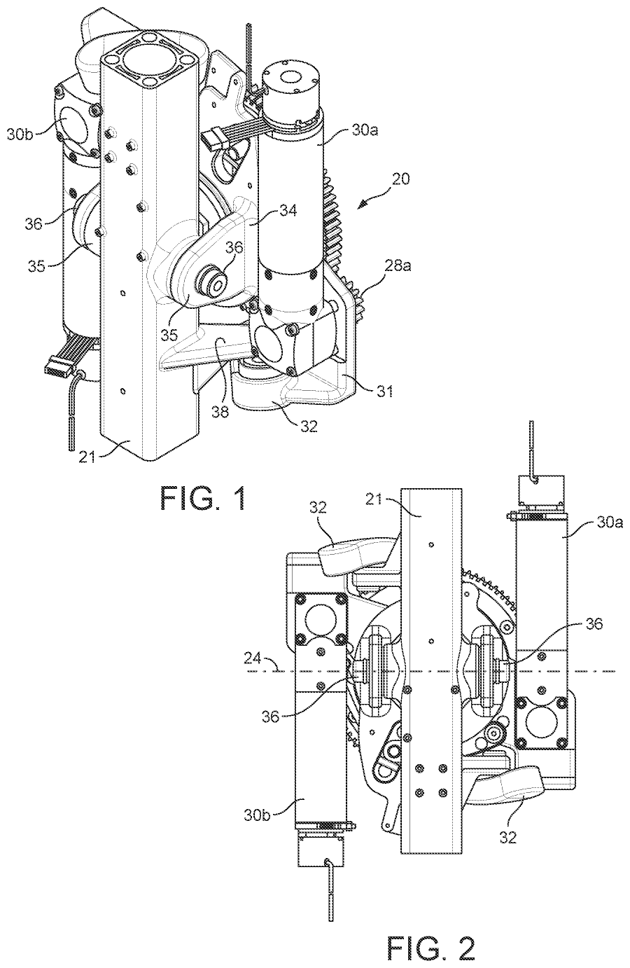

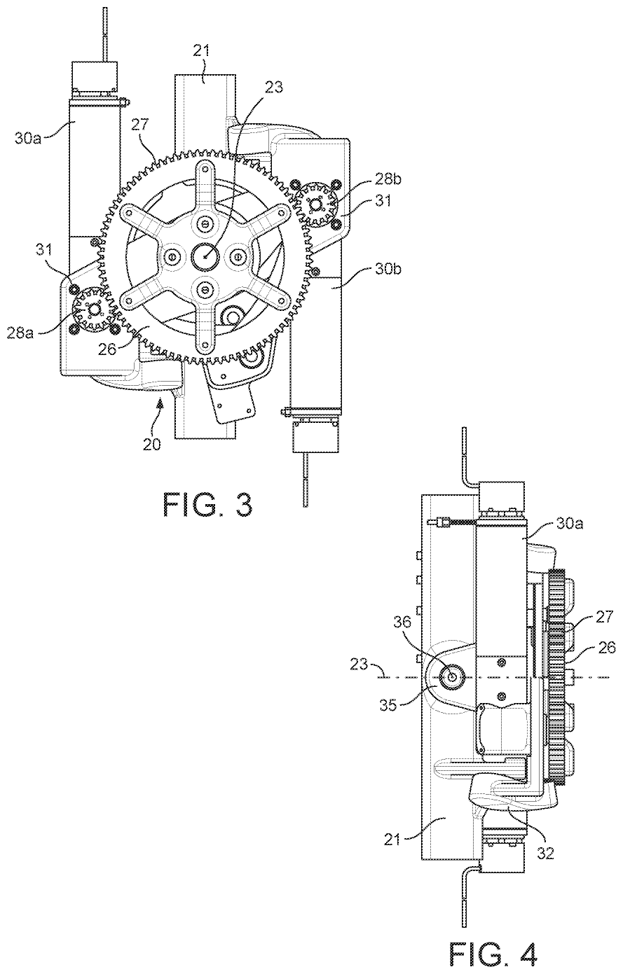

It can be seen from the Figures that the level drive motors 30a and 30b are mounted in opposite senses to minimise the space occupied by the levelling arrangement and further, to provide balanced leverage about the pitch axis 24 as will be described in greater detail below. This, in turn, means that the pinions 28a. 28b engage with the levelling wheel 26 on opposites sides of a vertical and a horizontal diameter of the levelling wheel. In the neutral or level position, such as is shown in FIGS. 1 to 4, the pinions are located at opposite ends of a diameter of the levelling wheel and this also applies when the level drive motors are being driven in the same directions to compensate for roll as shown in FIG. 5.

The motor mount plates 31 are mounted on the rear of a yoke 34 such that the combined rotation of the motor mount plates about roll axis 23 is transferred to the yoke 34. As can be seen, the yoke has a pair of spaced arms 35 between which the load support 21 is received in bearings 36, a line through the centres of bearings 36 defining the second or pitch axis 24. Thus, as the level drive motors 30a, 30b are powered in the same direction to migrate the pinons 28a, 28b about the toothed periphery 27 of the levelling wheel, the yoke 34 is pivoted about the roll axis 23.

Independently of the connection between the yoke 34 and the load support 21, second

and third connections are provided between the load support and the motor mount plates 31 to control movement about the pitch axis 24. In the example illustrated the second connection components comprise two arms 38 that project from the load support 21 at positions that are located on opposite sides of the pitch axis 24 and which are configured to allow engagement with the guide slots 33 in brackets 32 on the motor mount plates 31. As can be seen in FIGS. 7 & 8, mounted on each projecting arm 38 is a third component of the linkage is a sliding member, preferably in the form of a bearing 40 that locates within the respective guide slot 33. It can be seen in FIG. 8 that the base surface 42 of each guide slot 33 is curved to ensure smooth sliding action of the slots 33 relative to the bearings 40. The curvature is preferably principally dictated by the distance from the pitch axis of the contact between slot 33 and bearing 40; but may also take into account the distance of that contact from the roll axis.

It will be appreciated that, when control is applied to drive the level drive motors 30a, 30b in the same direction, the mid-positions of the slots 33 are located over the bearings 40. However, when control is applied to drive the level drive motors in opposite directions the interaction between the angled slots 33 and the bearings 40 cause the slots 33 to slide over the bearings and the motor mount plates to rotate in opposite directions about the roll axis 23. Since the guide slots are angled relative to the pitch axis, and the arms on which the bearings are mounted are spaced from the pitch axis, leverage is applied to the load support in a manner that causes the load support to pivot within yoke 34 about the pitch axis 24.

By selecting that motor to be driven in a clockwise direction and that motor to be driven in an anti-clockwise direction, compensation can be induced for either positive or negative pitch.

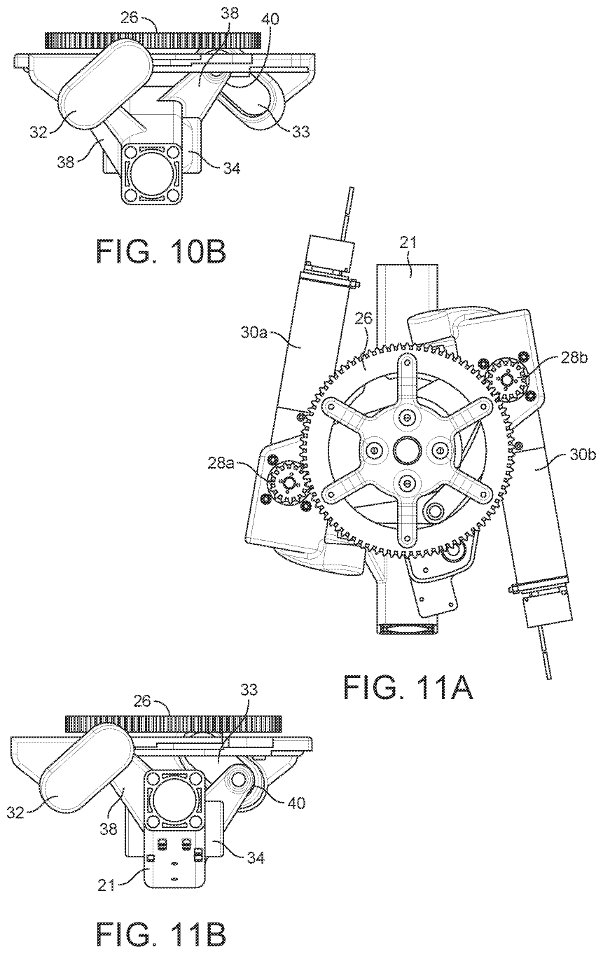

In the example shown in FIGS. 10A & 10B, to induce negative pitch, titling the load support forward, motor 30b is driven in a clockwise direction while motor 30a is driven in an anti-clockwise direction; and the inner ends of guide slots 33 are driven into contact with the bearings 40. The opposite or positive pitch, shown in FIG. 11, tilts the load support back. In this instance motor 30b is driven in an anti-clockwise direction while motor 30a is driven in a clockwise direction; and the outer ends of guide slots 33 are driven into contact with the bearings 40.

Control over the motors 30a and 30b is preferably programmed into the stairlift electronic control unit (ECU). The ECU may, for example, be ‘mapped’ with the level requirements at various positions of the carriage on the rail such as is described in our published International Patent Application WO95/18763 resulting in the motors being controlled at all times to keep the chair level or substantially level.

Variations to the embodiment described may be adopted without departing from the scope of the invention. By way of example only, the yoke 34 could be replaced by ball and socket joint and/or the mechanical linkage including slots 33 and bearings 40 could be replaced by a pushrod arrangement.

1. A stairlift comprising:
a stairlift rail;
a carriage mounted on said rail for movement there-along;
a load support mounted on said carriage, said load support being mounted on said carriage for pivotable movement with respect to the carriage about a first or roll axis, and about a second or pitch axis substantially perpendicular to said roll axis; and
a plurality of level drive motors configured and operable in a first mode to rotate said load carrier about said roll axis;
wherein said stairlift further includes a linkage between said plurality of level drive motors and said load carrier, said linkage being configured to apply drive from said plurality of level drive motors, when operated in a second mode, to pivot said load carrier about said pitch axis.

2. The stairlift as claimed in claim 1, wherein said roll axis and said pitch axis intersect.

3. The stairlift as claimed in claim 1, wherein, in said first mode, said plurality of level drive motors are driven in the same direction and, in said second mode, said plurality of level drive motors are driven in opposite directions.

4. The stairlift as claimed in claim 3, wherein said carriage includes a yoke configured to define said pitch axis and to receive said load support; and a pair of motor mount plates mounted to pivot about said roll axis, one of said plurality of level drive motors being mounted on each of said motor mount plates, said linkage engaging said load support at one or more positions spaced from said pitch axis such that, when said level drive motors are operated in said second mode, said motor mount plates are caused to pivot about said roll yoke about said pitch axis.

5. The stairlift as claimed in claim 4, wherein said linkage comprises in first part of a plurality of guide slots extending from said motor mount plates and angled with respect to said pitch axis; in second part of a plurality of arms extending from said load support, from positions on said load support spaced equidistant from said pitch axis; and in third part of a plurality of sliding connections extending between said guide slots and said arms and configured to control sliding movement of said guide slots relative to said arms.

6. The stairlift as claimed in claim 5, wherein said sliding connections comprise or include bearings.

7. The stairlift as claimed in claim 5, wherein each of said guide slots includes a curved base surface.

8. The stairlift as claimed in claim 5, wherein said guide slots are aligned at substantially 45° to said pitch axis.

9. The stairlift as claimed in claim 5, wherein said guide slots have a length and wherein said linkage is configured such that, when said level drive motors are driven in said first mode, each connection is positioned substantially midway along the length of its respective guide slot.

10. The stairlift as claimed in a claim 1, wherein each of said plurality of level drive motors includes a drive pinion in engagement with a levelling wheel mounted on said roll axis, the respective drive pinions being positioned to engage said levelling wheel on opposite sides of a vertical diameter thereof.

11. The stairlift as claimed in claim 10, wherein, when said level drive motors are operating in said first mode, said drive pinions engage said levelling wheel at opposite ends of a diameter thereof.

12. The stairlift as claimed in claim 10, wherein said drive pinions are positioned to engage said levelling wheel on opposite sides of a horizontal diameter thereof.
